(19) United States
(12) Patent Application Publication
(10) Pub. No.: US 2008/0019481 A1
(43) Pub. Date: Jan. 24, 2008

(54) MONOCHROMATIC X-RAY SOURCE AND X-RAY MICROSCOPE USING ONE SUCH SOURCE

(76) Inventor: Jean-Pierre Moy, Saint Egreve (FR)

Correspondence Address: BURR & BROWN, PO BOX 7068, SYRACUSE, NY, 13261-7068, US

(21) Appl. No.: 11/844,699

(22) Filed: Aug. 24, 2007

Related U.S. Application Data
(63) Continuation of application No. PCT/FR2006/050136, filed on Feb. 14, 2006.

(30) Foreign Application Priority Data
Mar. 2, 2005 (FR) 0550548

(51) Int. Cl. H05G 2/00; G21G 4/00; H01J 35/00

(52) U.S. Cl. 378/119

(57) ABSTRACT

This monochromatic X-ray source comprises a target in particular made from a material incorporating emitting ions comprising an element, the said atoms being excited by electron bombardment, essentially by the electrons located on the K layers of the said atoms. The target material is generally in the solid state and it is held together by means of structuring atoms representing one or more elements and bound to the emitting atoms, the said structuring atoms having an absorption coefficient equal to or lower than 2.3 μm⁻¹ for the X-rays emitted by the emitting atoms.

### FIELD OF THE INVENTION

The present invention relates to X-ray sources called “soft”, in particular sources used to form X-ray microscope images. X-ray microscopy is used in particular for imaging in the areas of biological analysis or research, because it serves to form images having better spatial resolutions than the images formed in visible or ultraviolet light, because of its shorter radiation wavelength.

### PRIOR ART

It is known how to employ “soft” or long wavelength X-ray sources, that is, having an energy substantially between 300 and 2000 eV. Thus, document WO-01/46962 describes a device in which a water jet is subjected to an electron bombardment so that the K layer electrons of the oxygen present in the water emit “soft” X photons during their deexcitation.

This technique serves in particular to emit “soft” X-rays in the “water window”, that is, X-rays whereof the energy is between the K threshold of carbon at 284 eV and the K threshold of oxygen at 543 eV, which corresponds to wavelengths between 4.4 nm and 2.3 nm. In fact, this energy range constitutes the preferable range for biological analysis, because organic materials, wherein carbon is the predominant element, are 10 to 20 times more absorbent than water, which often constitutes the major portion of the samples analyzed. Well contrasted images of organic materials can thereby be observed.

However, such a water jet X-ray source, owing to the liquid nature of the target, is obviously difficult to use and may lack stability, hence reproducibility. Furthermore and above all, its application is limited by the fact that the boiling point of the water jet under very low pressure limits the power of the electron beam to an excessively low level to obtain the necessary brightness for high image resolution. Thus, with such a source added to an electron beam whereof the power is limited to 0.6 W, it is only possible to reach a brightness of about 5.10⁸ photon/s. μm².sr by emitting in a line having a band width of 3.8 eV.

In fact, the brightness necessary for high image resolution is rather about 5.10¹⁰ photon/s. μm².sr in a relatively limited spectral band, that is having a ratio of the central wavelength to the wave breadth (λ/Δλ)of about 300 to 500 (that is a band width of 1 to 1.8 eV). In consequence, the spectral brightness necessary is about:
2×10¹⁰ photons/s. μm².sr.0.1%BW (“Band Width”).

In fact, to obtain an image having sufficient resolution and contrast, the sensor, consisting for example of one million pixels, should receive about 1000 photons/pixel; hence this requires one billion photons detected per image. In fact, if we consider that:
the efficiency of the lens is 10%,
the X-ray transmission through the object is 10%,
the quantum yield of the detector (conversion of photons to electric charges) is 70%,
the capacitor efficiency is 10%,
   the number of necessary photons accordingly becomes:
   10⁹/(70%×10%×10%×10%)=1.4.10¹²

In fact, if the exposure lasts about 10 seconds and if the object is observed under a solid angle of 7.8×10⁻³ sr (aperture f10 on an object 20 μm in diameter for example), the necessary brightness is accordingly:
1.4×10¹²/(10×20²×7.8.10⁻³)=5.10¹⁰ photons/s. μm².sr.

Similarly, the use of electrical discharge plasmas to emit X-rays cannot provide a sufficient brightness, because the dimensions of the source are too large.

Moreover, such a brightness is available in the radiation centres called “synchrotrons”. However, these centres are dedicated to research and are unsuitable for conducting rapid and frequent analyses of biological samples by X-ray microscopy. Furthermore, the facilities are extremely costly and bulky, particularly because of the considerable shielding they require. In consequence, they are unsuitable for laboratory analyses.

Linear accelerators are unusable for similar reasons (size, cost, hazard), although they also serve to obtain the brightness and band width necessary by means of a Cerenkov effect emission issuing from the bombardment of a thin metal sheet (of titanium or vanadium) by a very high energy (about 10 MeV) electron beam.

Another solution for obtaining such a brightness resides in the use of plasmas generated by very short pulse of a LASER beam focused on a target containing nitrogen or carbon. The atoms thus bombarded are ionised and the transitions of layers by their electrons cause the emission of X photons in the “water window”. By adopting the appropriate operating parameters (LASER of 100 Hz to 1 kHz frequency and 100 mJ energy), an emission can be obtained providing the necessary brightness with extremely narrow band width rays (λ/Δλ=300 to 1000). However, other rays are simultaneously emitted, accordingly requiring selective filtering. Moreover, the target may disintegrate, hence demanding the protection of the X-ray processing optics against these fragments, and frequent replacement of the shielding of the optics. This emission method therefore proves to be very costly and impractical.

It is therefore the object of the present invention to provide an X-ray source having very good performance in terms of power, brightness, band width, at low cost, being easy to use and not producing any fragments.

### SUMMARY OF THE INVENTION

The invention therefore relates to a monochromatic X-ray source, comprising a target in particular made from a material incorporating emitting atoms consisting of a type of element (belonging to the Periodic Table of Elements), the said atoms being excited by electron bombardment, essentially by the electrons located on the K layer of the said elements.

According to the invention, this material is generally in the solid state and is held together by means of structuring atoms bound to the emitting atoms. Furthermore, according to the invention, the said structuring atoms have a photon energy absorption coefficient equal to or lower than a predefined threshold.

This threshold is defined so as to observe substantially a transmission of at least 10% of the outgoing radiation emitted by the deepest emitting atoms (located about 1 μm from the target surface) reached by the electron beam.

Thus, the invention resides in an X-ray source, wherein the target comprises a material in the solid state comprising atoms of at least two elements, the emitting atoms and the structuring atoms, the structuring atoms being unable to excessively filter the X-rays emitted by the emitting atoms.

Advantageously, the absorption capacity threshold previously defined is equal to or lower than 10%. In this way, at least 10% of the X-rays emitted leave the target and can be used. On account of the laws of physics involved, and particularly the Lambert-Beer Law, this is equivalent to using structuring atoms whereof the absorption coefficient is equal to or lower than 2.3 μm⁻¹. In fact, the transmission according to this law obeys the equation:
T=e^{-μ.1}
where μ denotes the absorption coefficient and 1 the depth in the target,

Hence the value of μ≦2.3 m⁻¹ obtained for a transmission equal to or greater than 10% with 1≈1 μm.

According to a particularly advantageous embodiment, the atomic numbers of the said structuring atoms are lower than the atomic number of the said emitting atoms. In this way, the structuring atoms only slightly filter the X-rays emitted by the emitting atoms.

Advantageously, particularly for biological analysis, the emitting atoms are oxygen atoms, the said material being entirely or partially in oxide form.

In practice, the structuring atoms are beryllium atoms, in oxide form, and particularly beryllium monoxide (BeO). In this case, the proportion of X-rays absorbed by the beryllium structuring atoms is low.

Alternatively, the emitting atoms are nitrogen atoms, hence the target material is entirely or partially in nitride form.

In practice, the structuring atoms are boron atoms, forming a target in nitride form defined by boron nitride (BN).

Simultaneously, heavier elements than the emitting elements may exist, whereof the L layer electrons have a slightly higher energy than the energy of the X-rays emitted by the said emitting elements. Accordingly, these elements have a sufficiently low absorption of the X-rays emitted by the emitting elements for the said elements to be suitable as structuring elements.

In practice, the emitting atoms are oxygen atoms and the structuring atoms are magnesium atoms and aluminium atoms, forming a target in oxide form defined by magnesium aluminate (MgAl₂O₄), or even atoms of chromium and manganese.

In an advantageous embodiment of the invention, the target is coated entirely or partially with a high radiation coefficient material, in order to allow the removal by radiation of the heat generated during the electron bombardment of the target.

Preferably, the radiation coefficient of the said high radiation coefficient material is equal to or higher than 0.7 for the emission of radiation with wavelengths between 1 and 10 μm.

In practice, for the implementation of this embodiment of the invention, the high radiation coefficient material employed is nickel black.

Advantageously, the target is entirely or partially located opposite heat conductors, the said conductors being coated entirely or partially with high radiation coefficient material, in order to collect the radiation issuing from the target. Furthermore, a fluid flows inside the said conductors in order to cool them by convection.

In another practical embodiment of the invention, the electron bombardment beam is focused and tilted to the normal at its impact point on the target.

Preferably for this practical embodiment of the invention, the value of the angle of inclination of the electron bombardment beam to the normal at its impact point on the target is between 40° and 70°.

Advantageously, the part of the target capable of being exposed to the said beam is coated with a superficial layer of a refractory material, conducting electricity and having a low absorption of the emitted X-rays or of the bombardment electrons.

Preferably, the refractory material has an emitted X-ray energy absorption coefficient equal to or lower than 2.3 μm⁻¹.

In practice, this refractory material is selected from the group comprising chromium, nickel, cobalt or an oxide thereof, particularly chromium oxide (III), having the formula Cr₂O₃.

Advantageously, the source further comprises a reserve having the same chemical composition as the said refractory material added on to the target, the said reserve being capable of being exposed to the electron bombardment beam in order to cause the sublimation of part of the said refractory material constituting the target, thereby to reconstitute the said superficial layer.

According to another advantageous embodiment of the invention, the target has a symmetry of revolution and it is rotated about its axis of revolution and relative to the electron bombardment beam.

According to a practical aspect of this embodiment, the thickness of the target varies generally decreasingly with increasing distance from the axis of revolution of the target.

In practice, the target is assembled by brazing on a material having an expansion coefficient and a Poisson's ratio close to those of the target material.

The invention also relates to a microscope equipped with at least one X-ray source as defined previously.

### BRIEF DESCRIPTION OF THE FIGURES

The invention will appear more clearly in light of the description of the following particular embodiments, with reference to the figures appended hereto, However, the object of the invention is not limited to these particular embodiments and other embodiments of the invention are possible.

FIG. 1 is a schematic representation of the anode of an X-ray source according to a first particular embodiment of the invention.

FIG. 2 is a schematic representation of the anode of an X-ray source according to another particular embodiment of the invention.

### EMBODIMENT OF THE INVENTION

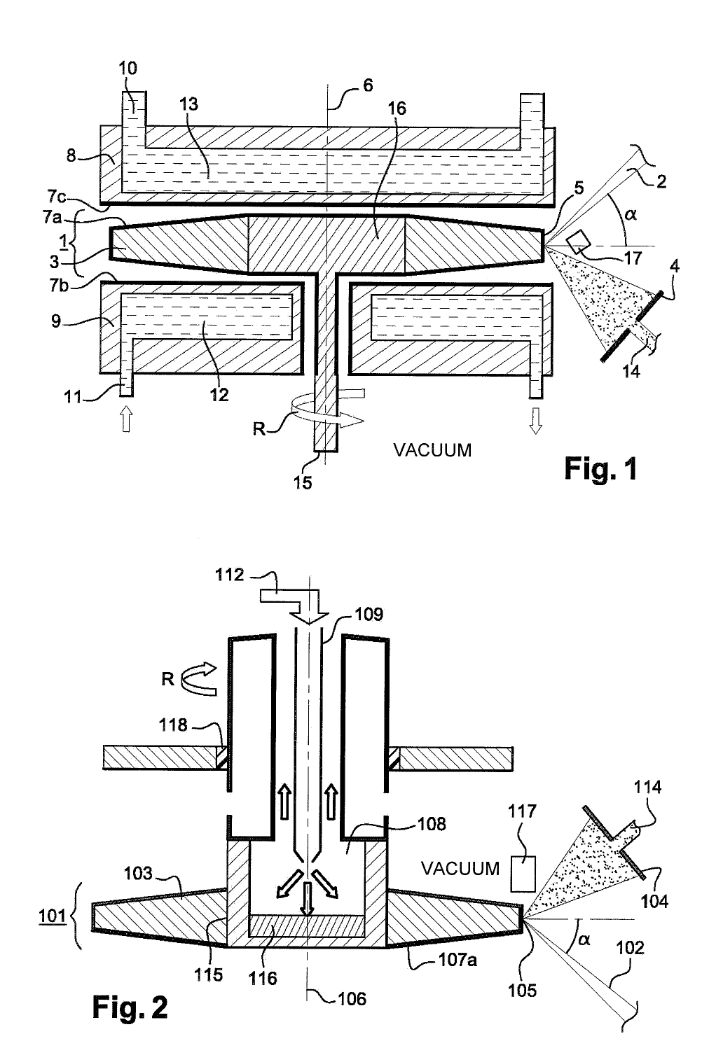

FIG. 1 shows an X-ray source, whereof the target (1) comprises in particular a material (3) in the solid state, comprising emitting atoms bound to structuring atoms. In the example described below, the structuring atoms represent a single element of the Periodic Table and have a lower atomic number than that of the said emitting atoms. In the present case, the material (3) of the target (1) is a ceramic prepared from beryllium monoxide (BeO), in which the oxygen atoms constitute the emitting atoms in the sense of the invention, while the beryllium atoms play the role of the structuring atoms.

However, the material (3) could also consist of a composite ceramic of beryllium and beryllium oxide (Be-BeO), or even comprise boron oxide (B₂0₃), where the oxygen atoms constitute the emitting atoms, while the boron atoms constitute the structuring atoms.

Among the other materials suitable for constituting the target (1) according to the present invention, mention can be made of lithium borates (LiBₓO_{y}), boron nitride (BN), magnesium oxide (MgO), chromium oxide (Cr₂O₃), magnesium aluminate (MgAl₂O₄), etc. It is also feasible to use these substances separately or in combination with one another, in the form of juxtaposed materials.

The target (1) constitutes the anode of the X-ray source. As it appears from FIG. 1, the target (1) is bombarded by an electron beam (2). The energy of the bombardment beam (2) is sufficient to excite the electrons located on the K layers of the emitting atoms of the material of the target (1). The emitting atoms are therefore mainly located in the zone reached by the beam (2).

The current and voltage of the cathode of the X-ray source (not shown) may, for example, be respectively between 3 and 50 kV and between 10 and 50 mA.

However, a different acceleration voltage and/or cathode current are feasible, particularly for optimizing the conversion of the bombardment electron beam to X-rays, whereof the absorption by the materials of the target (1) would be low.

It should be observed here that the choice of beryllium monoxide is judicious, because its absorption of X-rays emitted at an energy corresponding to the K line of oxygen, or 525 eV, is relatively low (μ=0.7 μm⁻¹), while the absorption of X-rays emitted in the K line of beryllium, also capable of emitting during the bombardment of the target (1) by the beam (2), is fairly high (μ=7 μm⁻¹). It should also be noted that a high acceleration voltage increases the penetration of the beam (2), thereby permitting a greater distribution of the heat generated during the bombardment into the volume of the target (1).

In fact, experience shows that the absorption of the emitted X-rays generally increases with an increase in the atomic number(s) of the elements selected to constitute the structuring atoms. However, considerable discontinuities occur in this increase when the bonding energy of an electron layer of the structuring element exceeds the value of the energy of the X-rays emitted by the emitting atoms. This is why various elements are suitable for preparing the invention, the said elements being primarily characterized by the levels of bonding energy of their electrons.

It has been observed that the source according to the invention, wherein the target (1) comprises particularly a ceramic of beryllium monoxide (3), emits X-rays in the K line of oxygen with an energy of 525 eV and a width of 1.2 eV (that is, a spectral fineness of λ/Δλ=452), which corresponds to the natural width of the K line of oxygen in a crystal of beryllium monoxide (BeO). Furthermore, the permissible power of the beam (2) is 300 W for a source according to the invention, while it is only 0.6 W for a water jet source; the brightness obtained with beryllium monoxide (3) reaches 5×10¹⁰ photons/s. μm².sr, or about 100 times the brightness accessible with a water jet source (5×10⁸ photons/s. μm².sr). That is, a spectral brightness of 10¹⁰ photons/s. μm².sr.0.1% BW.

As already observed elsewhere, the bombardment by the beam (2) causes heating of the target (1) particularly in the impact zone (5). To maintain the target in proper operating condition, the target (1) must be prevented from overheating beyond the melting point of the material whereof it is made. This is why the target (1), with a symmetry of revolution, is rotated along the arrow R about its axis of revolution (6), as is frequently the case for X-ray sources, qualified accordingly as “rotating anode” sources. Thus, the impact zone (5) is constantly renewed and cooled between two consecutive exposures to the beam (2) so that the impact zone (5) cannot reach its melting point.

The minimum speed of rotation is determined experimentally or by calculation, in order to satisfy the limit temperature condition mentioned above. For example, for a 100 W energy beam (2) focused on an area of about 20 μm×40 μm of the target (1) of beryllium oxide (3) (thermal conductivity at 1000 K=50 W/m.K) and ignoring the radiation losses, the time of exposure to the beam (2) must be shorter than 100 ns to avoid exceeding a temperature of about 1500 K. This leads to the determination of the peripheral speed of the target of 200 m/s, and the speed of rotation as a function of the diameter of the rotating anode, for example, a speed of rotation of 400 revolutions/sec for a diameter of 150 mm.

Furthermore, to prevent the overheating of the rotating anode, it may be provided to remove the heat generated in operation. For this purpose, the target (1) is coated over a large part of its surface with a layer of emissive material (7a), consisting, in the example described, of nickel black, with a high radiation coefficient, higher than 0.7, the coefficient ε in this case is 0.9.

The layer of emissive material may be directly in contact with the target (1) or indirectly via a layer of another material, to ensure the bonding of the emissive material. When the temperature of the ceramic (3) arises, the heat is transmitted to the overall part (3), because the said part is made from a good thermally conducting material (thermal conductivity of BeO at 800 K=70 W/m.K), and the heat is then transmitted to the layer of emissive material (7a), which then emits a radiation (essentially infrared) to the exterior of the part (3), thereby contributing to the cooling thereof.

As shown in FIG. 1, the removal of the heat from the part (3) can be improved by mounting opposite and around it heat exchangers (8, 9), also coated with a layer of emissive material (7b, 7c), also good heat conductors. The optimal geometry and positioning of these heat exchangers can be determined by a person skilled in the art empirically or by calculation. One criterion for defining the geometry and positioning of these heat exchangers (8, 9) consists in that the radiation of the largest possible number of points of the target (1) is collected by the heat exchangers at a solid angle close to 2π sr. This serves to optimise the heat exchange by radiation between the opposing surfaces, and thereby, to remove a high heat energy.

Finally, the heat removal can be further improved by cooling the heat exchangers (8, 9) which preferably remain static, by means of two heat transfer fluids (12, 13) flowing in ad hoc lines (10, 11) provided inside the said heat exchangers (8, 9). The heat transfer fluids (12, 13) cool the heat exchangers (8, 9), by convection, and thereby contribute to the cooling and therefore the structural stability of the target (1).

FIG. 2 shows another feasible construction for cooling by convection using a heat transfer fluid (112) flowing in a volume (108) provided for this purpose, the rotating cryogenic target (101) of beryllium oxide (103). The fluid (112) employed in this example is liquid nitrogen, which passes by gravity through an axial tube (109) up to the central volume (108) of the target (101). The liquid nitrogen (112) accumulates therein against a target core (116) made from a high heat capacity material, such as aluminium, and then flows along the outer walls of the axial tube (109) during the rotation of the target (101). In operation, the equilibrium temperature of the combination consisting of the target (1) and the axial tube (109) may reach 77 K.

In fact, such a cooling of the target (101) is especially advantageous if the latter has a high thermal conductivity at low temperature that is much higher than the high temperature thermal conductivity. Thus, for temperatures between 80 K and 200 K, the thermal conductivity of beryllium oxide exceeds 800 W/m.K. Such a construction therefore serves to better dissipate the heat liberated due to the electron bombardment of the target (101).

In consequence, it is possible to limit the speed of rotation of the target (101) compared with a less cooled target, and thereby, reduce the mechanical stresses generated during the rotation on the beryllium oxide ceramic (103).

Instead of a target with a rotating source, it is possible to consider a source according to the invention and having a fixed cryogenic target, cooled to very low temperature (77 K). However, dissipating a heat capacity of between 100 W and 300 W for an area from 20 to 30 μm in diameter would require the target to have a thickness of a few microns, which would make it fragile.

Furthermore, as known in the prior art, the target (1; 101) and the parts surrounding it are placed under vacuum to permit the propagation of the bombardment electrons (2; 102) and the X-rays subsequently emitted (14; 114).

Moreover, it may be possible to tilt the beam (2; 102), which is focused on a spot from 10 to 30 μm in diameter, with regard to the normal at its impact point (5; 105) on the target (1, 101) by an angle α of between 40° and 70°. Thus, the thermal stress applied on the impact zone (5; 105) is better distributed (by a factor of 1.5 to 3 compared with a normal incidence). To make suitable use of the resulting beam (14; 114), the collector would have to be inclined symmetrically with regard to the beam (14, 114).

It is also known that an X-ray source contains electron currents at the level of the impact zone (5; 105) of the beam (2; 102). It is therefore necessary to remove these currents. This is why the source according to the invention is coated at the impact zone (5; 105) with a layer of refractory and conducting material in order to remove these currents. This layer is therefore in the form of a strip at least 40 μm wide and extending completely around the target (1, 101).

The thickness and the absorption coefficient (which is proportional to the atomic number) of this layer must be sufficiently low to avoid excessively absorbing the X-rays emitted. In the example in the figures, the chromium layer has a thickness of between 20 and 40 nm. It only absorbs about 10% of the X-rays emitted by oxygen at an energy of 525 eV, because the energy threshold of the L layer of chromium is located at 574 eV and it is therefore not excitable by lower energy photons, such as those emitted in the K line of oxygen, by the source shown in the figures. Other materials are suitable for constituting this layer, such as chromium, nickel, cobalt or one of the oxides thereof, and more particularly chromium oxide (III), with the formula Cr₂O₃, known for its good electrical conductivity.

It should be noted that the composite material (Be-BeO) being a conductor of electricity, a target made from this material makes the addition of the chromium layer unnecessary. This composite is also a good heat conductor, but its maximum operating temperature is about 1200 K, compared with 2200 K for beryllium monoxide. Furthermore, its content of emitting atoms (the oxygen atoms in this case) is lower than that of beryllium monoxide.

Moreover, to complete the removal of the electron currents, the emissive material (7a) coating most of the surface of the target (1) is also a conductor and drains the charges to earth via the axis of rotation (15).

It has been observed that this thin layer of electrically conducting material may be damaged by local evaporation under the action of the heat generated in operation. In fact, it is important for the layer of this heat removal strip to remain uninterrupted in order to perform its primary function. This is why, according to one advantageous feature of the invention, a reserve (17; 117) of this material is added onto the target (1) near the impact point (5; 105) where the electron beam (2; 102) bombards the target (1). In this way, the reserve (17, 117) can be bombarded by the electron beam (2; 102) slightly deviated from its usual path. The reserve (17; 117) is thereby sublimated when exposed long enough to the beam (2; 102) and it contributes to restoring the continuity of the layer of conducting material. The parameters of the restoration process are not given in greater detail here, because they are part of the general knowledge of a person skilled in the art.

Furthermore, when the target (1) or rotating anode is rotated, it is subject to high mechanical stresses. For example, for a 150 mm diameter disc, the speed of rotation to be reached is about 400 revolutions/sec, considering the peripheral speed of 200 m/s indicated above. This is why it is necessary to ensure that the target (1) is capable of withstanding the mechanical stresses associated with such a speed of rotation and, whenever possible, of minimizing them.

Firstly, this criterion guides the choice of the material of the target (1). In fact, beryllium monoxide, like the composite (Be-BeO), has very good mechanical properties, enabling it to withstand these stresses associated with the rotation of the target (1). Thus, the breaking strength of beryllium monoxide is 100 MPa at a temperature of 500 K and the target according to the invention accordingly withstands electron beam power densities substantially exceeding 100 kW/mm².

As indicated previously, other materials may be suitable for preparing a target according to the invention. This is the case of boron nitride (BN) which emits in the K line of nitrogen with an energy of 392 eV, which has good thermal properties (maximum temperature of use 2500 K, conductivity 30 W/m.K), and also good mechanical properties (breaking strength 100 MPa at a temperature of 500 K).

This is also the case of magnesium oxide (MgO), emitting in the K line of magnesium with an energy of 1254 eV. Furthermore, other materials can also be used to prepare a source according to the invention, which nevertheless have thermal and/or mechanical properties which are less appropriate to the application to a rotating anode. For example, boron oxide (III), having the formula B₂O₃, lithium oxide (I), having the formula Li₂O, or lithium borates, having the general formula LiBₓO_{y}, can be employed.

Subsequently, the target (1; 101) can be machined according to a geometry designed to reduce the stresses due to rotation. Thus, to decrease the moment of inertia of the target (1; 101) and thereby reduce these stresses, the target has a thickness, measured along the cross section of the target (1; 101) by a radial plane, which varies generally decreasingly with increasing distance from the axis of revolution of the target (1; 101).

The variation in the thickness of the target may be linear, as it appears from FIG. 1, or quadratic or even may be defined by another mathematical function. The variation may be continuous or discontinuous, insofar as it remains generally decreasing with increasing distance from the axis of revolution (6; 106) of the target (1; 101), that is, that the thickness measured at the periphery of the ring or disc forming the target (1; 101) is lower than the thickness measured close to its axis (6; 106).

Finally, the target (1) may be provided in a plurality of parts, consisting of different materials, insofar as they are suitable for withstanding the mechanical and thermal stresses previously discussed. It is thus desirable to provide the axis and the support (16) of the ceramic (3) of a material having suitable thermal and mechanical properties. In fact, experience shows that the temperature of the target (1) decreases as one “approaches” the axis. The support (16) material must be selected in order to have a Poisson's ratio and an expansion coefficient close to those of the ceramic (3) to ensure good cohesion of the assembly, even under high mechanical and thermal stresses, and hence, good transmission of these stresses. Titanium and some of its alloys are suitable for forming the support (16) because they have the desired thermal and mechanical properties as well as Poisson's ratios and expansion coefficients (v˜0.32; k˜9 μm/m.K) which are similar, at the temperatures considered, to those of beryllium monoxide (v˜0.30; k˜μm/m.K).

The assembly of the beryllium monoxide (3) ceramic to the titanium support (16) is prepared by brazing, that is, without melting of the assembled materials. Furthermore, the axis of rotation (15) is provided to be hollow in order to increase its thermal resistance, thereby favouring the removal of the heat by radiation and avoiding the transmission of thermal stresses to the parts exercising the rotational movement (not shown). Obviously, the target (1) must be machined with care, and then dynamically balanced in order to avoid, as much as possible, the inertial stresses, and hence vibrations, associated with geometric irregularities. For the same reason, the rotation drive must be prepared with great accuracy.

In the example in FIG. 2, the support (116) is also made from an alloy selected for its thermal and mechanical properties, particularly for its Poisson's ratio and expansion coefficient (v˜0.32; k˜9 μm/m.K) similar, at the temperatures considered, to those of beryllium monoxide (v˜0.30; k˜8 μm/m.K).

Furthermore, a ferro-fluid seal (118), known per se, may be provided, designed, on the one hand, to guarantee the tightness of the target (101) enclosure, in order to maintain an adequate vacuum therein, and on the other hand, to conduct the undesirable electron currents.

Moreover, the structuring atoms (beryllium in this case), are also liable to emit X-rays in their own K lines. However these rays, which have lower energy than those emitted by the emitting atoms, can be filtered by a device known per se, installed for example in a collimator (4) located on the path of the X-rays between the target (1) and the object to be analyzed (not shown). In this way, these “undesirable” rays are unable to degrade the image of the object and/or expose it to a needlessly high dose of ionizing radiation.

A further advantage of beryllium monoxide for its use as a target resides in the fact that it emits few Bremsstrahlung X-rays, particularly because of the low atomic numbers of its components. In fact, the conversion of the electron energy to Bremsstrahlung radiation has a yield proportional to the atomic number and to the acceleration voltage, and is a function of the target geometry. The emission of Bremsstrahlung radiation is therefore lower if the atomic number of the bombarded elements is low.

In a manner known per se, the deexcitation of the electrons of the K layers of the emitting atoms is accompanied by the emission of X photons. The X-rays thus emitted by the target (1) are contained in the “water window”. They have an energy between the K threshold of carbon at 284 eV and the K threshold of oxygen at 543 eV, that is, wavelengths of between 4.4 nm and 2.3 nm. This energy range constitutes a perfectly appropriate range for biological analysis, because it serves to form well contrasted images of organic materials, due to the wide difference in absorption (factor of 10 to 20) of the rays by carbon and by water, which respectively constitute the major part of the organic materials and samples investigated.

Furthermore, it should be noted that beryllium monoxide must be handled with appropriate safety measures, because it is highly toxic. Nevertheless, for the application considered here, the risks of exposure, hence of intoxication, are limited to the target (1) machining phase. In fact, this material is subsequently in the form of a stable and isolated ceramic under vacuum, thereby reducing the risks of intoxication.

For the understanding of the summary, the example developed here concerns an X-ray source emitting at energy levels comprised within the water window. However, the subject matter of the invention, as it appears from claim 1 for example, also relates to X-ray sources emitting at other energy levels.

1. Monochromatic X-ray source, comprising a target in particular made from a material incorporating emitting atoms comprising an element, the said atoms being excited by electron bombardment, essentially by the electrons located on the K layers of the said atoms, wherein said material is generally in the solid state and in that it is held together by means of structuring atoms representing one or more elements and bound to the emitting atoms, the said structuring atoms having an absorption coefficient equal to or lower than 2.3 μm⁻¹ for the X-rays emitted by the emitting atoms.

2. Monochromatic X-ray source according to claim 1, wherein the atomic numbers of the said structuring atoms are lower than the atomic number of the said emitting atoms.

3. Monochromatic X-ray source according to claim 1, wherein said emitting atoms are oxygen atoms, the said material being entirely or partially in oxide form.

4. Monochromatic X-ray source according to claim 3, wherein said structuring atoms are beryllium atoms and in that the said oxide form is beryllium monoxide (BeO).

5. Monochromatic X-ray source according to claim 1, wherein said emitting atoms are nitrogen atoms, the said material being entirely or partially in nitride form.

6. Monochromatic X-ray source according to claim 5, wherein said structuring atoms are boron atoms and in that the said nitride form is boron nitride (BN).

7. Monochromatic X-ray source according to claim 1, wherein said emitting atoms are oxygen atoms and in that the said structuring atoms are magnesium atoms and aluminium atoms, the said oxide form being magnesium aluminate (MgAl₂O₄).

8. Monochromatic X-ray source according to claim 1, wherein said emitting atoms are oxygen atoms and in that the said structuring atoms are selected from chromium and manganese.

9. Monochromatic X-ray source according to claim 1, wherein the target is coated entirely or partially with a high radiation coefficient material, in order to allow the removal by radiation of the heat generated during the electron bombardment of the target.

10. Monochromatic X-ray source according to claim 9, wherein the radiation coefficient of the said high radiation coefficient material is equal to or higher than 0.7 for the emission of radiation with wavelengths between 1 and 10 μm.

11. Monochromatic X-ray source according to claim 9, wherein said high radiation coefficient material consists of nickel black.

12. Monochromatic X-ray source according to claim 9, wherein the target is entirely or partially located opposite heat exchangers, the said conductors being coated entirely or partially with high radiation coefficient material, in order to collect the radiation issuing from the target, a fluid flowing inside the said conductors to cool them by convection.

13. Monochromatic X-ray source according to claim 12, wherein the radiation coefficient of the said high radiation coefficient material is equal to or higher than 0.7 for the emission of radiation with wavelengths between 1 and 10 μm.

14. Monochromatic X-ray source according to claim 1, wherein the electron bombardment beam is focused and tilted to the normal at its impact point on the target.

15. Monochromatic X-ray source according to claim 14, wherein the value of the angle α of inclination of the electron bombardment beam to the normal at its impact point on the target is between 40° and 70°.

16. Monochromatic X-ray source according to claim 1, wherein the part of the target (capable of being exposed to the said beam is coated with a superficial layer of a refractory material, conducting electricity and having a low absorption of the emitted X-rays or of the bombardment electrons.

17. Monochromatic X-ray source according to claim 16, wherein said refractory material is selected from the group comprising chromium, nickel, cobalt or an oxide thereof, particularly chromium oxide (III), having the formula Cr₂O₃.

18. Monochromatic X-ray source according to claim 16, wherein it further comprises a reserve having the same chemical composition as the said refractory material added on to the target, the said reserve being capable of being exposed to the electron bombardment beam in order to cause the sublimation of part of the said refractory material, thereby to reconstitute the said superficial layer.

19. Monochromatic X-ray source according to claim 1, wherein the target of revolution and in that it is rotated about its axis of revolution and relative to the electron bombardment beam.

20. Monochromatic X-ray source according to claim 19, wherein the thickness of the target varies generally decreasingly with increasing distance from its axis of revolution.

21. Monochromatic X-ray source according to claim 1, wherein the target is assembled by brazing on a material having an expansion coefficient and a Poisson's ratio close to those of the target material.

22. X-ray microscope wherein it comprises at least one X-ray source according to claim 1.
